(19) United States
(12) Patent Application Publication
(10) Pub. No.: US 2011/0068494 A1
(43) Pub. Date: Mar. 24, 2011

(54) FABRICATION OF MICROSCALE TOOLING

(76) Inventors: Robert W. Wilson, Austin, TX (US); Levent Biyikli, Cedar Park, TX (US); Yi Lu, Austin, TX (US)

(21) Appl. No.: 12/993,014

(22) PCT Filed: May 7, 2009
(86) PCT No.: PCT/US09/43124

§ 371 Date: Nov. 16, 2010

Related U.S. Application Data
(60) Provisional application No. 61/055,615, filed on May 23, 2008.

(51) Int. Cl. B29C 59/16

(52) U.S. Cl. 264/1.27; 264/447

(57) ABSTRACT

The present disclosure is directed to a process for making a tooling that may subsequently be used to make a microstructured article. The process detailed herein describes the formation of microstructured tooling structures in patterns to form microstructured arrays on a substrate to create the master tool. The process comprises providing a partially transparent substrate coated with a photo-polymerizable liquid on a first surface of the substrate. The master tool created can subsequently be used to fashion replication tools which in turn can be used to make light guides.

### FIELD OF THE INVENTION

This application relates to an optical direct write method for fabricating a microstructured tool or article.

### BACKGROUND

Articles with a microstructured topography include those having a plurality of structures on a surface thereof (projections, depressions, grooves and the like) wherein the structures are micro-scale in at least two dimensions. The microstructured topography may be created in or on the article by any contacting technique, such as, for example, casting, coating or compressing. Typically, the microstructured topography may be made by at least one of: (1) casting on a tool with a microstructured pattern, (2) coating on a structured film with a microstructured pattern, such as a release liner, or (3) passing the article through a nip roll to compress the article against a substrate having a microstructured pattern.

The topography of the tool used to create the microstructured pattern in the article or film may be made using any known technique, such as, for example, chemical etching, mechanical etching, laser ablation, photolithography, stereolithography, micromachining, knurling, cutting or scoring. The machine tool industry is capable of creating a wide variety of patterns required to make microstructured articles, and Euclidean geometric patterns can be formed with varying patterns of size, shape, and depth/height of projections. Tools can range from planar presses to cylindrical drums and other curvilinear shapes.

However, machining a metal tool to make a microstructured article to a customer's specification can be a time consuming process. In addition, once a metal tool is machined, it is difficult and expensive to alter the microstructured pattern in response to changing customer requirements. This machining time can introduce production delays and increase overall costs, so methods are needed to reduce the time required to make a tool suitable for the production of microstructured articles.

In a field which requires rapid prototyping and short product lifetimes such as is frequently the case in the electronics industry, a less time consuming and cost effective method of producing tooling to create microstructured articles is desired. Having a process that can make larger format tooling than is currently available with conventional methods would also be advantageous.

### SUMMARY

The present disclosure is directed to a process for making a replication tool that may subsequently be used to make a microstructured article. The process detailed herein describes the formation of microstructured tooling structures in patterns to form microstructured arrays on a substrate to create the master tool. The master tool created can then be used to fashion replication tools which in turn can be used to make desired articles, e.g. light guides.

The process of making the replication tool begins by forming a master tool. The master tool is formed on a partially transparent substrate. The substrate is coated with a photo-polymerizable liquid on a first surface of the substrate. The photo-polymerizable liquid can be exposed to a light beam which is introduced into the photo-polymerizable liquid through the substrate at a first position. The light beam can have sufficient beam characteristics to cure the photo-polymerizable liquid to form a first tooling structure. The beam characteristics include a beam shape, a beam intensity profile, a total beam intensity and an exposure time. A portion of the photo-polymerizable liquid in contact with the surface of the substrate may be cured to form the first tooling structure. The substrate is translated relative to the light beam. The exposing, curing steps and translating steps may be repeated a plurality of times to create an array of tooling structures. After formation of the array of tooling structures, the uncured photo-polymerizable liquid is removed.

The replication tool is formed by placing a formable material against a surface of the master tool. A negative contour of the array of tooling structures on the master tool is transferred into the formable material. The formable material is then removed from the master tool to yield the replication tool.

The above summary of the present invention is not intended to describe each illustrated embodiment or every implementation of the present invention. The figures and the detailed description that follow more particularly exemplify these embodiments.

### BRIEF DESCRIPTION OF THE DRAWINGS

The present invention will be further described with reference to the accompanying drawings, wherein:

FIG. 1A is an illustration showing the formation of a single tooling structure in accordance with the present invention;

FIG. 1B is a schematic illustration of an exemplary tooling structure in accordance with the present invention;

FIG. 2A shows a schematic representation of an exemplary apparatus for writing of tooling structures in accordance with the present invention;

FIG. 2B shows a schematic representation of an exemplary process for forming tooling structures on a master tool in accordance with the present invention;

FIG. 2C shows a schematic representation of an exemplary process for forming a replication tool in accordance with the present invention;

FIG. 3 shows a photomicrograph of an exemplary single tooling structure formed in accordance with the present invention;

FIG. 4 shows a photomicrograph of exemplary single tooling structures formed in accordance with the present invention;

FIG. 5 shows a photomicrograph of an exemplary array of tooling structures formed in accordance with the present invention;

FIG. 6 shows a photomicrograph of another exemplary array of tooling structures formed in accordance with the present invention; and

FIG. 7 shows a photomicrograph of additional exemplary tooling structures formed in accordance with the present invention.

FIG. 8 shows a photomicrograph of a section of a master tool formed in accordance with the present invention.

FIG. 9 shows a photomicrograph of a replication tool formed with the master tool of FIG. 8, in accordance with the present invention.

FIG. 10 shows a photomicrograph of a second generation replica formed with the replication tool of FIG. 9, in accordance with the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

In the following detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized and that structural or logical changes may be made without departing from the scope of the present invention. The following detailed description, therefore, is not to be taken in a limiting sense, and the scope of the present invention is defined by the appended claims.

The present disclosure is directed to a process for making a master tool that may subsequently be used to make a microstructured article. As noted above, microstructured articles have a topography with structures on a surface thereof (projections, depressions, grooves and the like) that are micro-scale in at least two dimensions. The term micro-scale as used herein refers to dimensions that are difficult to resolve by the human eye without aid of a microscope. In some cases, a dimension of a microstructure is less than 500 μm, or less than 200 μm, or less than 100 μm.

The process detailed herein describes the formation of microstructured patterns, such as a microstructured array, on a substrate to create a master tool. The microstructured patterns may include, for example, protruding structures, continuous and discontinuous grooves, ridges, and combinations thereof.

The substrate used to make the master tool can vary widely. In some cases, the substrate material can be sufficiently rigid, flat and stable to allow accurate creation of the microstructured array. The substrate should be transparent to the wavelength of light used to generate the structures of the array. Suitable substrate materials include, but are not limited to glass, quartz, or rigid or flexible polymeric materials.

The microstructures can vary in shape. For example, bases can be circular, elliptical or polygonal and the resulting side walls can be characterized by a vertical cross section (taken perpendicular to the base) that is generally spherical, elliptical, parabolic, hyperbolic, or a combination thereof. Preferably, the side walls are not perpendicular to the base of the structure (for example, angles of about 10 degrees to about 80 degrees) can be utilized. The structures can have a principal axis connecting the center of its top with the center of its base.

By combining a plurality of these microstructures, more complicated structures and array patterns may be formed. The array can have a variety of packing arrangements including regular arrangements (e.g., square or hexagonal) or irregular arrangements such as a random array. The size and shape of the structures in the array can also vary throughout the array or may form localized regions of similar structures. For example, the heights can be varied according to the distance of a particular structure from a particular point or line.

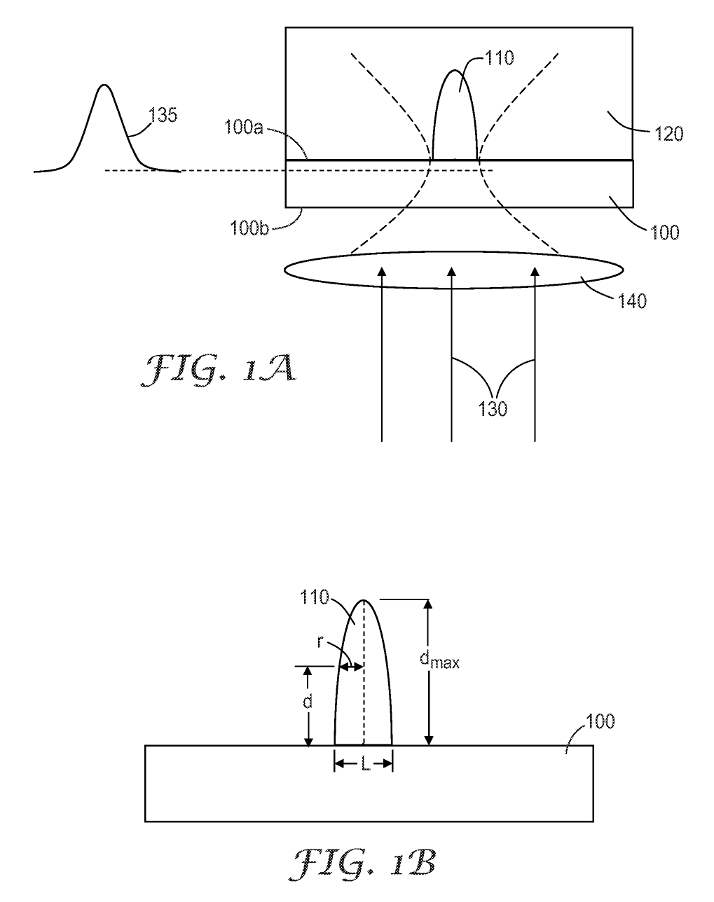

Referring to FIG. 1B, for example, the process described herein can be used to fabricate arrays with structures having heights, dₘₐₓ, in the range of about 5 μm to about 500 μm (preferably, about 10 μm to about 300 μm) and/or maximum lengths, L, and/or maximum widths in the range of about 5 μm to about 500 μm (preferably, about 10 μm to about 300 μm; more preferably, about 50 μm to about 250 μm).

The master tool can include several thousand tooling structures that can produce a corresponding number of structures in a replication tool. The replication tool can be formed by applying a formable material against the tooling structures on the master tool. The formable material may be applied by casting the a curable material on the master tool having tooling structures on its surface, or passing film of thermoformable material through a nip roll to compress the thermoformable material against the master tool having tooling structures on its surface.

A second generation replica can be formed in a similar manner by applying a second formable material against the surface of the textured replication tool.

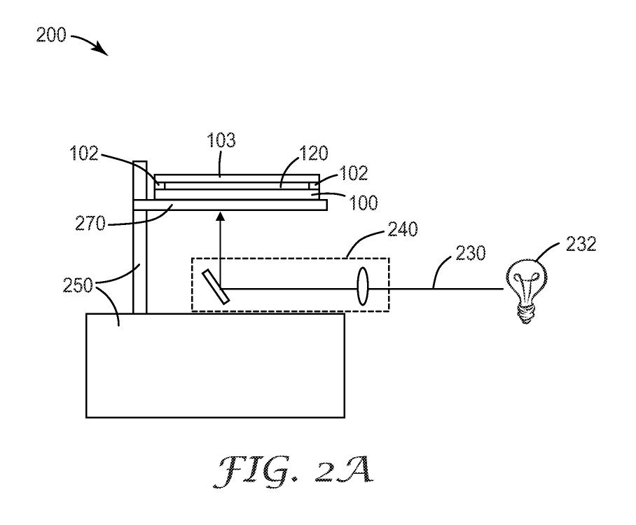

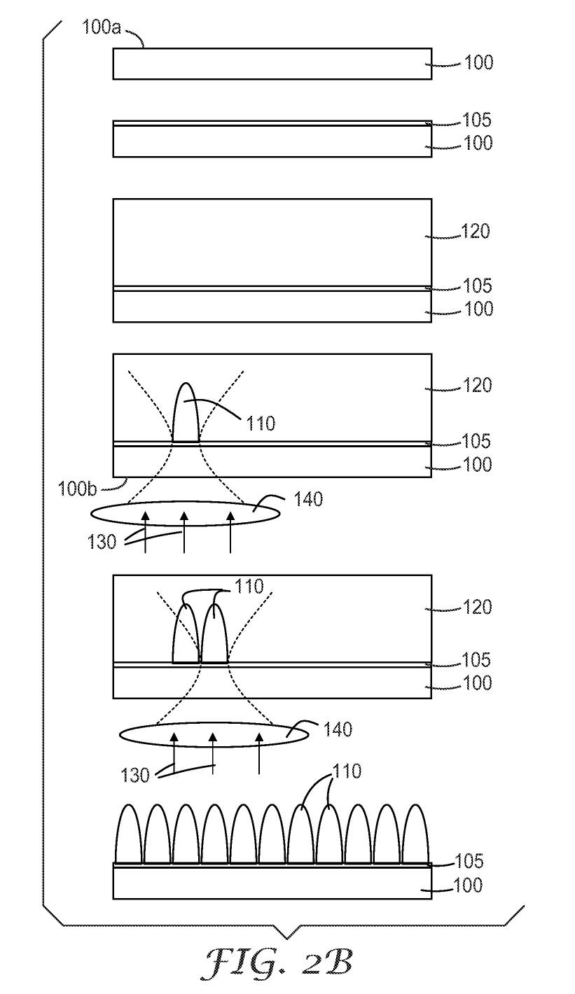

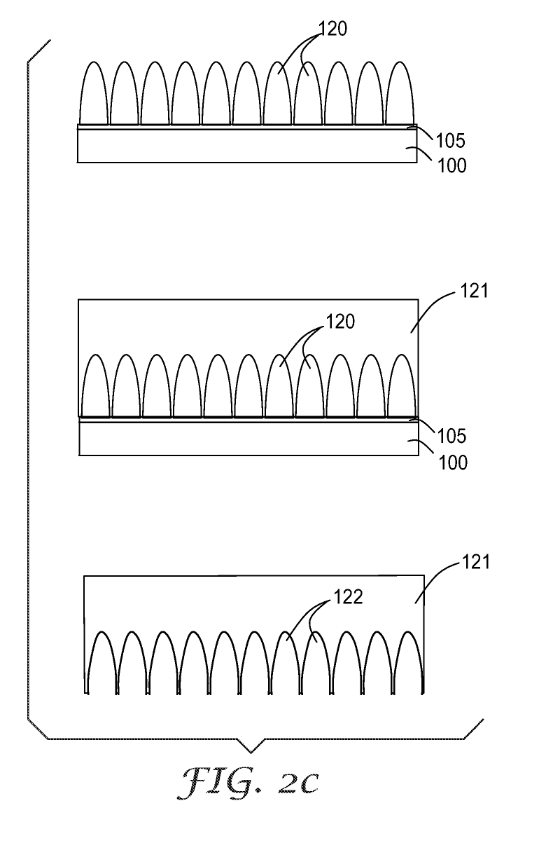

In an exemplary method, the process of forming a master tool having micro-scale three dimensional structures can be used to create the tooling structures for a light extraction material. This process can be described with reference to FIG. 1A and FIG. 2B.

As shown in FIG. 1A, tooling structures 110 can be formed on a substrate 100 by briefly exposing a photo-polymerizable material or liquid 120 disposed on a first surface 100a to an actinic light beam 130 from a light source not shown. The light beam 130 is incident on a second surface 100b as it passes through substrate 100. The light source may be a broad spectrum light source such as a mercury vapor bulb or a source having a discrete wavelength profile such as a laser or a laser diode. The light beam 130 is passed through beam shaping optics 140 to shape and focus the light beam before it is used to expose photo-polymerizable liquid 120. The beam shaping optics 140 may include lenses, filters, mirrors, photomasks or a combination thereof. Substrate 100 should be partially transparent to the wavelength of light beam 130 used initiate the polymerization of the photo-polymerizable liquid 120. For example, the substrate should have a transparency of greater than 10% (preferably greater than 50%; more preferably greater than 90%) at the wavelength(s) of light being used to cure the photo-polymerizable liquid. The light beam passes through the substrate such that the beam is generally perpendicular to the substrate, although it is possible for the light beam to pass through the substrate angles that are not perpendicular to the substrate.

Upon exposure, a portion of the photo-polymerizable liquid will polymerize to a depth that is determined by the beam characteristics such as the intensity profile of the actinic light beam, the total intensity of the light beam, the exposure time, and the response characteristics of the photo-polymerizable liquid. When the intensity profile 135 of the light beam is Gaussian and the photo-polymerizable material responds such that the depth of polymerization is a logarithmic function of exposure, master tools with structures conforming to sections of parabaloids can be generated using single light exposures.

In carrying out the process of the invention, photo-polymerizable liquid can be exposed to a light beam having a sufficient total intensity to trigger the polymerization or cross-linking of the photo-polymerizable liquid. The other characteristics of the light beam (i.e. shape of the light beam, the light beams intensity profile and the length of the exposure of the photo-polymerizable liquid to the light beam) will control the final shape of the tooling structure written by this process described herein. These beam characteristics can be selected beforehand by the user.

One exemplary fabrication system that can be used to carry out the process of the invention is shown in FIG. 2A. Fabrication system 200 includes light source 232, beam shaping optics 240 that can include a plurality of mirrors, apertures, masks and lenses to define the intensity profile and shape of the light beam and moveable stage system 250. Stage system 250 is moveable in three dimensions and may include one, two or three individual stages that work in concert and are precisely controlled by a controller (not shown). Substrate 100, having the photo-polymerizable liquid 120 applied to the top surface thereof, can be supported on stage system 250 by a mount 270.

Light beam 230 originating from light source 232 passes through beam shaping optics 240 and can be introduced to the photo-polymerizable liquid 120 through the substrate 100. In regions of the photo-polymerizable liquid 120 where the light exposure is sufficient to cause polymerization, the photo-polymerizable liquid 120 will polymerize to form a tooling structure. In regions of the photo-polymerizable liquid 120 where the light exposure is insufficient to cause polymerization, the photo-polymerizable liquid does not react and will remain a low viscosity liquid. In one aspect of the invention, the light beam used to expose and cure the photo-polymerizable liquid passes through an optical system which does not utilize a photomask to shape the light beam.

A subsequent tooling structure may be formed at a second position in the photo-polymerizable liquid after substrate 100 has been moved by the stage system 250. Alternatively the light beam may be directed to a second position on the substrate, for example, by moving a laser beam using galvo-mirrors, piezo-mirrors, or acousto-optic deflectors and a telescope or by moving one or more elements of beam shaping optical system 240. In this way, the focal point of the light beam can be scanned or translated across the substrate in concert with repeated exposures to produce an array of tooling structures. In either aspect, the light beam and the exposed portion of the photo-polymerizable liquid are moveable relative to each other.

In an alternative aspect of an apparatus for writing tooling structure, at least one beam splitter or other multiplexing optical component (not shown) may be added if the light source is of a sufficient energy level. The addition of the at least one beam splitter will allow the writing of more than one tooling structure or more than one array of tooling structures at a time without substantially increasing the cost of the apparatus.

An exemplary process for making a master tool is shown in FIG. 2B. A substrate 100 is provided and coated with an optional adhesion promoter 105 on the first surface 100a of the substrate. The adhesion promoter can be coated onto the surface of the substrate by any of a variety of coating methods known to those skilled in the art including, for example, dip coating, knife coating, and spin coating. The adhesion promotion layer can improve the adhesion of the tooling structures 110 to the substrate 100 to help ensure longer tool life.

Suitable adhesion promoters include, but are not limited to 3-methacryloxypropyl trimethoxy silane, vinyltrimethoxy silane, chloropropyl trimethoxy silane, 3-glycidoxypropyl trimethoxy silane, 3-glycidoxypropyl trimethoxy silane, and combinations thereof.

Next, a photo-polymerizable liquid 120 is coated over the adhesion promotion layer by any of a variety of coating methods known to those skilled in the art including, for example, knife coating and flood coating. The substrate may have a dam 102 (FIG. 2A) formed around its outer perimeter to retain the photo-polymerizable liquid on the substrate during the writing of the structures. The depth of the liquid coated onto the substrate should be greater than or equal to height of the tooling structures to be produced. Additionally, an optional cover 103 (FIG. 2A) may be placed on top of dam 102 to prevent excessive evaporation of the photo-polymerizable liquid during the write process.

The photo-polymerizable liquid is a low viscosity liquid having a viscosity at room temperature of less than about 200 cP (preferably, less than about 40 cP). The photo-polymerizable material or liquid can include monomers and/or oligomers capable of photoactivated polymerization when an appropriate photo-initiator or photo-sensitizer is used. The photo-polymerizable liquid may also include a light absorbing material to attenuate the absorption characteristics and alter the response of the photo-polymerizable liquid.

The master tool made from the exemplary process describe above preferably has suitable ruggedness to survive multiple replication processes to produce a plurality of replication tools. Suitable photo-polymerizable monomer materials include, but are not limited to acrylic monomers such as mono-; di-; and poly-acrylates and methacrylates (for example, methyl acrylate, methyl methacrylate, ethyl acrylate, isopropyl methacrylate, n-hexyl acrylate, stearyl acrylate; allyl acrylate; glycerol diacrylate; glycerol triacrylate; ethylene glycol diacrylate; diethylene glycol diacrylate; triethylene glycol dimethacrylate; 1,3-propanediol diacrylate; 1,3-propanediol dimethacrylate; 1,6-hexanediol diacrylate; 1,6-hexanediol dimethacrylate; trimethylolpropane triacrylate; 1,2,4-butanetriol trimethacrylate; 1,4-cyclohexanediol diacrylate; pentaerythritol triacrylate; pentaerythritol tetraacrylate; pentaerythritol tetramethacrylate; and combinations thereof); silicone-based liquid photo-polymers; and epoxy based liquid photo-polymers.

Alternatively, the photo-polymerizable material may be in the form of a film of acrylate oligomer systems or poly-dimethylsiloxane oligomer systems that are capable of photo-activated polymerization or cross-inking when an appropriate photo initiator is used.

The oligomer materials can help to control the rheological properties of the photo-polymerizable liquid and is preferably soluble in the monomer material selected, as well as improving the mechanical properties of the master tool. Suitable oligomer materials include, but are not limited to epoxy resin based liquid photo-polymers, urethane acrylate oligomers, silicone acrylate oligomers and polyester acrylate oligomers. Alternatively, it is within the scope of this invention to include non-reactive polymeric binders in place of or in addition to the oligomer materials in the compositions in order, for example, to control viscosity of the photo-polymerizable liquid. Such polymeric binders can generally be chosen to be compatible with the monomer material. Binders can be of a molecular weight suitable to achieve desired solution rheology of the photo-polymerizable liquid.

The photo-polymerizable liquid also includes a photo-initiator or sensitizer. Any photo-initiator can be used that is compatible with the monomer, oligomer (if used) and matches its activation or absorption peak wavelengths to the light source being used to write the structures, e.g. the light source being used to initiate the polymerization of the photo-polymerizable liquid. Exemplary photo-initiator materials include, but are not limited to benzyldimethyl ketals such as IRGACURE 651, mono-acyl phosphines such as DAROCUR TPO, bis-acyl phosphines such as IRGACURE 819, and iodonium salt such as IRGACUR 784, each of which is available from Ciba Specialty Chemicals Inc. (Basel, Switzerland).

Suitable light absorber materials include, but are not limited to, functional benzophenones; benzotriazoles, such as Tinuvin 234, Tinuvin 326 available from Ciba Specialty Chemicals Inc. (Basel, Switzerland); and hydroxyphenyl triazines.

A wide variety of adjuvants can be optionally included in the photo-polymerizable liquid, depending upon the desired end use of the tooling structures. Suitable adjuvants include solvents, diluents, resins, binders, plasticizers, pigments, dyes, inorganic or organic reinforcing or extending fillers, thixotropic agents, indicators, inhibitors, stabilizers, and the like. The amounts and types of such adjuvants and their manner of addition to the compositions will be familiar to those skilled in the art.

Actinic radiation may be used to initiate polymerization of the photo-polymerizable liquid with collimated actinic radiation being preferred. A collimated actinic light beam 130 can be provided from a laser such as an argon ion laser (Sabre FreD) operating at 351 nm available from Innova Technology (Ellicott City, Md.) or a solid state laser operating at 405 nm (iFlex 2000) available from Point Source Ltd (Hamble, U. K.). The light beam 130 can be focused with a 100 mm focal length bi-convex lens through the substrate 100 into the photo-polymerizable liquid 120. In an exemplary embodiment, the cross sectional profile of the laser beam can be approximately Gaussian. The size of the beam at the substrate/photo-polymerizable liquid interface is controlled by positioning the substrate/photo-polymerizable liquid interface closer to or further from the focal point of the lens. The shape and intensity profile of the beam are controlled by the beam shaping optics as previously described. The exposure is controlled by adjusting the laser intensity and the exposure time.

The substrate can be placed on computer controlled X, Y, and Z stages to control the relative XY position as well as the Z position relative to the focal plane of the actinic light beam. In an alternative aspect, the surface of the substrate can remain stationary and the beam can be moved in the three axes using mirrors mounted on precision stages. Once a first tooling structure has been formed or written, the substrate can be translated in an x-direction and/or a y-direction to a new location. A second exposure can be made at this new location. The exposure conditions, intensity profile of the light beam, shape of the light beam and the total intensity of the light beam at this second location may be the same or different then the previous exposure conditions. If at least one of these beam conditions has been altered a second tooling structure having a different size or shape than the previously written tooling structures can be created. This process can be repeated in a stepwise manner until the desired array of tooling structures has been formed.

After a plurality of the tooling structures 110 have been formed, the non-polymerized photo-polymerizable liquid is removed using water, a solvent or an air knife. In some instances the tooling structures may be optionally rinsed with a small amount of the monomer material to facilitate removal of an unreacted photo-polymerizable liquid.

The tooling structures can be thereafter post cured by blanket exposure to UV light in a nitrogen purged chamber.

The tooling structures created by the above method are derived from conic sections of aspherical surfaces. In one exemplary use of these tooling structures, these structures can be useful as light extractors. The shape of these tooling structures can be described by the equation:

$$d = {d}_{max} - \frac{{cr}^{2}}{1 + \sqrt{1 - {c}^{2} {r}^{2} ( k + 1 )}}$$

where d is the height of the tooling structure at radius r, dₘₐₓ is the maximum height of the tooling structure 110 (FIG. 1B), c is the reciprocal of the radius of curvature, and k is the conic constant. When k=0, this equation describes a section of a sphere. When k=−1, the equation describes a section of a parabaloids which is a shape that is particularly useful as a light extractor. This paraboloid shape can be represented as

d=dₘₐₓ−cr²/2

In stereo-lithographic applications, it is often assumed that the response of the photo-polymerizable liquid can be described by the equation

d=S ln(Q/Q_{c})

where d is the polymerization depth, Q is the exposure which is a function of the light intensity and the exposure time, Q_{c} is the critical exposure needed to initiate polymerization, and S is the slope of the response curve. Q_{c} and S are properties of the photo-polymerizable material and may be modified by adjusting the formulation of the photo-polymerizable liquid.

The cross-sectional exposure from a laser beam having a Gaussian intensity profile is given by

Q=Qₘₐₓe^{-r}^{²}^{/w}^{²}

where Qₘₐₓ is the exposure at the center of the beam, Q is the exposure at radius r from the center of the beam, and w is the radius of the beam at the point where the intensity of the beam is equal to the maximum intensity divided by e.

Combining and reducing results in these expressions for the desired laser properties in terms of the properties of the photo-polymerizable material and the required shape, the following equations can be used to create the desired tooling structures,

w=\sqrt{2S/c}

and

Qₘₐₓ=Q_{c}e^{d}^{ₘₐₓ}^{/S}.

The shape of the tooling structure is determined by the width of the light beam and the slope of the response of the material. The width of the beam can be changed by moving closer to or further from the focus of the lens. The slope of the material response is controlled by the addition or removal of small amounts of the light absorber, the photo-initiator and/or and optional adjuvants. The critical exposure depends on the composition of the photo-polymerizable liquid including amount of photo-initiator present, the monomer characteristics, the presence of light absorbers and any additives that may absorb or scatter the radiation. For a given photo-polymerizable liquid composition and beam characteristics, the maximum height of the tooling structure, dₘₐₓ, is controlled by the laser exposure. The total intensity of the light beam is controlled by adjusting the output power of the laser, by the addition of filters to reduce the total intensity or by the use of an acousto-optic modulator. The exposure time can also be controlled by the acousto-optic modulator or by directly modulating the light source (e.g. the laser).

In another aspect of the invention, the light intensity profile and/or the shape of the light beam may be skewed by introducing at least one asymmetric optical element into the beam shaping optics. A skewed light intensity profile can be used to produce tooling structures having skewed profiles. Additionally, controlling primary axis of the light beam as it enters the photo-polymerizable liquid through the substrate enables the formation of extractor tooling structures that are tilted with respect to the plane of the substrate.

In yet another aspect of the invention, elongated tooling structures may be produced by dithering the light emitted by a laser back and forth during the exposure process. Alternatively, larger structures may be formed by overlapping individual single tooling structures. By controlling the direction and position of the dithering, more complex shapes such as ridges, crosses, tees, elbows and the like may be formed. Alternatively, elongated or complex tooling structures may be made by slow, yet continuous movement of the beam with respect to the substrate.

In yet another alternative aspect of the invention, truncated or flat-topped tooling structures may be created by controlling the depth of the photo-polymerizable solution coated onto the substrate. If the depth of penetration of the active portion of the light beam is greater than the depth of the photo-polymerizable solution coated onto the substrate, a truncated structure can be formed.

The master tool created by these processes can be used to replicate micro-lens arrays, gain diffusers for LCD displays, structures for reflective or illuminated signs, backlights for automobile dashboards and floating image creation.

FIG. 2C illustrates the preparation of a replication tool using the master tool prepared as described above. That is, a formable material 121 can be placed against the surface of the master tool on which an array of tooling structures was formed. A negative contour 122 of the array of tooling structures on the master tool is transferred into the formable material by known replication processes such as molding, embossing, or curing the formable material. The formable material may be a thermoplastic polymer or a curable resin, such as a silicone elastomers, an epoxy resin, or other polymer resin system. The formable material can be placed against the master to prepare a replication tool having the negative contour or image of the array structure of the master tool. The master tool can then be removed, leaving a replication tool that can subsequently be used to prepare additional arrays having the same features as the master tool. Alternatively, a conductive replication tool may be formed by electroplating or electroforming a metal, such as nickel, or other electrolytically deposited formable material onto a conductively coated (e.g. electroless silver plated) surface of the master tool.

Second generation and further generation replicas can be formed in a similar manner as the replication tool by apply a suitable second formable material against the surface of the tool created in a prior replication step. In this way, a single master tool can be used to create a vast number of final microstructured articles.

The microstructured articles made from these tools can be light guides or light extractors for use in electronic devices. Many electronic devices require the use of backlights to accentuate or illuminate features of the device. A common example is the backlighting of the keypads on mobile phones. These backlights consist of an edge lit polymer waveguide that contains light extraction structures that are designed to direct the light out of the waveguide at specific locations as determined by the application. As an example, in a mobile phone application the light extraction structures may lie beneath the keys to provide light to illuminate the keys. The size, shape, and location of the light extraction structures are determined by the desired lighting effect, the size and thickness of the waveguide and the type and position of the edge light or lights. The backlights are produced by forming a transparent polymer against one of the exemplary tools describe herein (i.e. the master tool, the replication tool, a second generation replica, etc.). Contact of the transparent polymer with the microstructured surfaces of one of these tools can be used to produce the light extraction structures in the extractor sheet.

The master tool can include several thousand tooling structures that can produce a corresponding number of negative contour structures in the replication tool, which in turn can be used to form positive contour structures in a second generation replica, and so on. A final article, for example, an extractor sheet can be formed by casting a transparent polymer material on one of the exemplary tools having microstructures on its surface described herein. Alternatively, an extractor sheet can be formed by passing transparent film of extractor sheet material through a nip roll to compress the extractor sheet material against an exemplary tool having tooling structures on its surface.

Light guides using the light extraction structure arrays of the invention can be fabricated from a wide variety of optically suitable materials including polycarbonates; polyacrylates such as polymethylmethacrylate; polystyrene; and glass; with high refractive index materials such as polyacrylates and polycarbonates being preferred. The light guides preferably are made by molding, embossing, curing, or otherwise forming an injection moldable resin against the above-described replication tool. Most preferably, a cast and cure technique is utilized. Methods for molding, embossing, or curing the light guide will be familiar to those skilled in the art. Coatings (for example, reflective coatings of thin metal) can be applied to at least a portion of one or more surfaces of the light guides (for example, to the interior or recessed surface of light extraction structures) by known methods, if desired.

The light guides of the present invention can be especially useful in backlit displays and keypads. A backlit display can include a light source, a light gating device (e.g. a liquid crystal display (LCD)), and a light guide. Keypads may include a light source and an array of pressure-sensitive switches at least a portion of which transmits light. The light guides are useful as point to area or line to area back light guides for subminiature or miniature display or keypad devices illuminated with light emitting diodes (LEDs) powered by small batteries. Suitable display devices include color or monochrome LCD devices for cell phones, pagers, personal digital assistants, clocks, watches, calculators, laptop computers, vehicular displays, and the like. Other display devices include flat panel displays such as laptop computer displays or desktop flat panel displays. Suitable backlit keypad devices include keypads for cell phones, pagers, personal digital assistants, calculators, vehicular displays, and the like

In addition to LEDs, other suitable light sources for displays and keypads include fluorescent lamps (for example, cold cathode fluorescent lamps), incandescent lamps, electroluminescent lights, and the like. The light sources can be mechanically held in any suitable manner in slots, cavities, or openings machined, molded, or otherwise formed in light transition areas of the light guides. Preferably, however, the light sources are embedded, potted, or bonded in the light transition areas in order to eliminate any air gaps or air interface surfaces between the light sources and surrounding light transition areas, thereby reducing light loss and increasing the light output emitted by the light guide. Such mounting of the light sources can be accomplished, for example, by bonding the light sources in the slots, cavities, or openings in the light transition areas using a sufficient quantity of a suitable embedding, potting, or bonding material. The slots, cavities, or openings can be on the top, bottom, sides, or back of the light transition areas. Bonding can also be accomplished by a variety of methods that do not incorporate extra material, for example, thermal bonding, heat staking, ultrasonic welding, plastic welding, and the like. Other methods of bonding include insert molding and casting around the light source(s).

### EXAMPLES

Objects and advantages of this invention are further illustrated by the following examples, but the particular materials and amounts thereof recited in these examples, as well as other conditions and details, should not be construed to unduly limit this invention.

### Example 1

A number of exemplary tool structures were prepared by coating a transparent glass substrate with a layer of photo-polymerizable epoxy resin, Somos 11120 available from DSM Somos (New Castle, Del.). The photo-polymerizable epoxy resin had a viscosity of about 130 cP. Collimated light from an Argon ion laser operating at 351 nm was focused with a lens through the glass into the photo-polymerizable liquid at a first position. The cross sectional profile of the beam was approximately Gaussian. The beam width at 1/e of the maximum was about 150 μm. The laser intensity was approximately 2 μW and each tooling structure was formed with a 0.4 second exposure. After exposure at the first position was completed, the substrate was translated to a second position and another exposure was made.

After several of the tooling structures were formed by exposure, the non-polymerized photo-polymerizable liquid was removed by rinsing with methanol and drying. Finally, the tooling structures were post cured by blanket exposure to UV light (maximum intensity at 365 nm) for 10 minutes in a nitrogen purged ELC-500 chamber (Electro Lite Corporation).

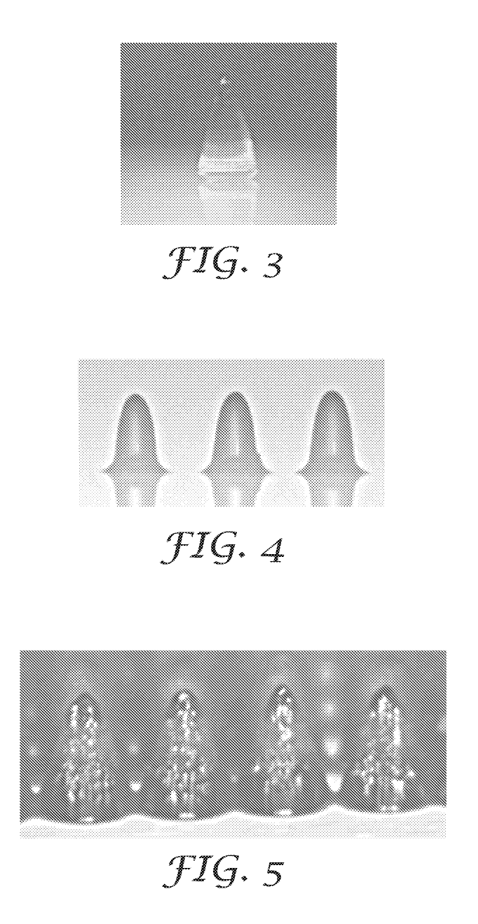

FIG. 3 shows a photomicrograph of a single tooling structure that was produced as described herein. The maximum height of the tooling structure was 230 μm and the width at the base was 140 μm.

### Example 2

A number of exemplary tooling structures were prepared by coating a transparent glass substrate with a thin layer of an adhesion promoter, 3-methacryloxypropyl trimethoxy silane (available from Alfa Aeser). Next, a layer of photo-polymerizable liquid was spread on the surface of the glass substrate. The photo-polymerizable liquid consisted of 1,6 hexanediol diacrylate, SR-238, available from Sartomer Company (Exton, Pa.) with 2% by weight of a photo-initiator, IRGACURE 651, available from Ciba Specialty Chemicals Inc. (Basel, Switzerland). This 1,6 hexanediol diacrylate based photo-polymerizable liquid had a viscosity of about 6 cP.

Collimated light from an Argon ion laser operating at 351 nm was focused with a lens through the substrate into the photo-polymerizable liquid at a first position. The cross sectional profile of the beam was approximately Gaussian. The beam width at 1/e of the maximum beam intensity was about 120 μm. The laser intensity was approximately 10 μW and each tooling structure was formed with a 0.4 second exposure. After exposure at the first position was completed, the sample was translated to a second position and another exposure was made.

After several of these tooling structures were formed, the unreacted photo-polymerizable liquid was removed using an air knife. Finally, the tooling structures were post cured by blanket exposure to UV light (maximum intensity at 365 nm) for 10 minutes in a nitrogen purged ELC-500 chamber (Electro Lite Corporation).

FIG. 4 shows a photomicrograph of three tooling structures that were produced as described herein. The maximum height of the tooling structures was 150 μm and the width at the base was 95 μm.

### Example 3

An exemplary patterned master tool was prepared by coating a transparent glass substrate with a thin layer of an adhesion promoter such as 3-methacryloxypropyl trimethoxy silane (available from Alfa Aeser). Next, a layer of photo-polymerizable liquid was spread on the surface of the glass substrate. The photo-polymerizable liquid consisted of a base photopolymer mixture of 20% by weight urethane acrylate oligomer, CN9008, available from Sartomer Company, Inc, (Exton, Pa.) and 80% by weight 1,6 hexanediol diacrylate, SR-238, also available from Sartomer Company. To this 2% by weight of a photo-initiator, IRGACURE 651, and 0.1% by weight of a light absorber, Tinuvin 234, both available from Ciba Specialty Chemicals Inc. (Basel, Switzerland), were added to the base photopolymer mixture to produce the photo-polymerizable liquid used.

Collimated light from an Argon ion laser operating at 351 nm was focused with a lens through the substrate into the photo-polymerizable liquid at a first position. The cross sectional profile of the beam was approximately Gaussian. The beam width at 1/e of the maximum was about 120 μm. The laser intensity was approximately 10 μW and each tooling structure was formed with a 0.8 second exposure.

After exposure at the first position was completed, the substrate was translated to a second position. This process was repeated until a rectangular area of surface of the substrate that was 4 mm by 7 mm was patterned. This produced an array of generally parabolic hill-shaped structures with center to center distances of 170 μm.

The laser intensity was then reduced to 2 μW and a second 4 mm by 8 mm rectangular area of closely spaced smaller tooling structures was produced by repeated exposures of 0.35 seconds.

After all of the tooling structures were formed, the unreacted photo-polymerizable liquid was removed using an air knife. Finally, the tooling structures were post cured by blanket exposure to UV light (maximum intensity at 365 nm) for 10 minutes in a nitrogen purged ELC-500 chamber (Electro Lite Corporation).

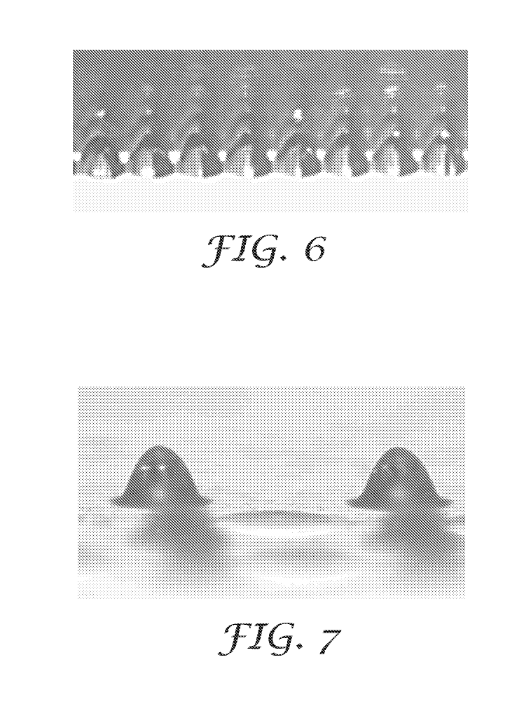

FIG. 5 shows a photo micrograph of an array of tooling structures that was produced. The maximum height of the tooling structures was 225 μm and the width at the base was 150 μm. FIG. 6 shows a photo micrograph of an array of smaller tooling structures in the second area. The maximum height of these tooling structures was 55 μm and the width at the base was 75 μm. The tooling structures were separated by 75 μm.

### Example 4

An exemplary patterned master tool was prepared by coating a transparent glass substrate with a thin layer of an adhesion promoter such as 3-methacryloxypropyl trimethoxy silane (available from Alfa Aeser). Next a layer of photo-polymerizable liquid was spread on the surface of the glass substrate. The photo-polymerizable liquid consisted of a base photopolymer mixture of 20% by weight urethane acrylate oligomer, CN9008, available from Sartomer Company, Inc, (Exton, Pa.) and 80% by weight 1,6 hexanediol diacrylate, SR-238, also available from Sartomer Company. To this 5% by weight of a photo-initiator, Darocur TPO, available from Ciba Specialty Chemicals Inc. (Basel, Switzerland), was added to the base photopolymer mixture to produce the photo-polymerizable liquid used.

Collimated light from a fiber coupled solid state ion laser at 405 nm (iFlex 2000) was focused with a lens through the glass into the photo-polymerizable liquid at a first position. The cross sectional profile of the beam was approximately Gaussian. The beam width at 1/e of the maximum was about 100 μm. The laser intensity was approximately 7.5 μW and each tooling structure was formed with a 0.175 second exposure.

FIG. 7 shows a photomicrograph of two tooling structures that were produced. The maximum height of the tooling structures was 120 μm and the width at the base of the structure was 160 μm.

### Example 5

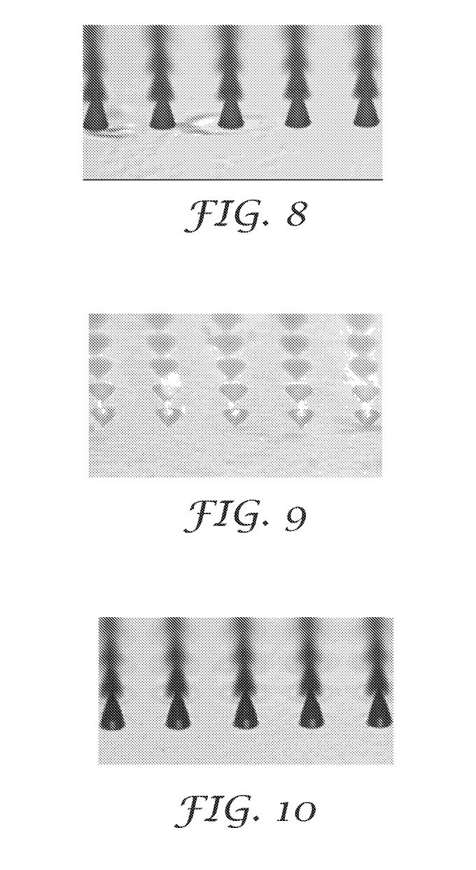

An exemplary replication tool was prepared using a master tool that was formed on accordance with to the process described with respect to Example 3. A photomicrograph of the section of the master tool used in making the replica is shown in FIG. 8. The maximum height of the tooling structures was 225 μm and the width at the base was 150 μm. The center to center spacing was 450 μm.

The exemplary replication tool was prepared using a forming material which was a liquid silicone casting resin kit, Sylgard™ 184 Silicone Elastomer Kit, available from Dow Corning (Midland, Mich.). The kit included a base material and a curing agent. The two parts were mixed at 10:1 (base:curing agent) weight ratio. The mixture was stirred vigorously at room temperature for 10 minutes. It was then placed in a vacuum chamber for ten minutes to degas. The silicone mixture was poured onto the master tool to form a 5 mm thick layer of the silicone on the surface of the master tool. To ensure a complete filling of the master tool, the silicone coated master tool was placed under vacuum for ten minutes. The silicone coated master tool was then heated on a hotplate at 90° C. for one hour, during which time the silicone mixture cured to form a flexible solid. The cured silicone replication tool was then separated from the master tool. The silicone replication tool is shown in FIG. 9.

To demonstrate making a second generation replica from the silicone replication tool, the same acrylate mixture that was used to make the tooling master was poured onto the silicone replica. An acrylate mixture containing base photopolymer mixture of 20% by weight urethane acrylate oligomer, CN9008, and 80% by weight 1,6 hexanediol diacrylate, SR-238; 2% by weight of a photoinitiator, IRGACURE 651; and 0.1% by weight of a light absorber, Tinuvin 234, was spread evenly over the surface of the silicone replication tool. After degassing under vacuum for 10 minutes, a glass substrate coated with an adhesion promoter, 3-methacryloxypropyl trimethoxy silane, was placed onto the surface of the acrylate mixture, sandwiching the acrylate mixture between the glass and the silicone replication tool. This assembly was then exposed to broadband UV light using an ELC-500 Light Exposure System, (Electro-Lite Corp.) at full power for 10 minutes under a nitrogen atmosphere. After curing, the silicone replica was separated from the glass substrate having the second generation acrylate replica adhered to the glass substrate's surface. A photomicrograph of the second generation replica is shown in FIG. 10.

The direct write method described herein has several advantages over conventional lithographic techniques. First, because the photo-polymerizable liquid remains a liquid throughout the process, additional chemical or plasma developing steps are not required to remove any unwanted material. Traditional lithography techniques typically use solvent, acidic or basic developers to remove unwanted photoresist material regardless if the photoresist is a dry film resist or a liquid resist which is dried prior to exposing the photoresist. Another disadvantage of using conventional developers is that the developer can damage, swell, or degrade the microstructures created during the patterning step. In some conventional lithography processes for creating microstructured surfaces, the photoresist is only used as a template for the creation of the microstructures. Additional deposition or plating steps may be required if an additive approach is used to form the microstructures or additional etching of the substrate may be done in a subtractive approach.

Liquid photoresists such as SU-8 available from Microchem (Newton, Mass.) require an additional soft bake step after coating to remove residual solvent and form a solid film. A standard process when using a liquid photoresist includes the steps of spin coating the resist material onto the substrate, soft baking to remove solvent and form the film into a resist, exposing to create the pattern, post expose bake to hard cure the resist and develop to remove uncured portions of the resist. An alternative development technique requires the sample be subjected to a reduced UV exposure to limit cross-linking so that the unexposed portions of the resist can be removed by heating to high temperature (i.e. greater than the glass transition temperature of the uncured resist material) in order to remove the uncured resist. This process may require a supplemental exposure step to complete the crosslinking of the resultant structures. Because a relatively low viscosity photo-polymerizable liquid is used in the direct method described herein, the removal of the uncured photo-polymerizable liquid can be accomplished at room temperature.

A second advantage is that the direct write method described herein does not require the use of a complex photomask which defines each individual microstructure element in order to produce the desired pattern. Instead, the direct write process uses the beam size and characteristics to produce the desired microstructures.

A third advantage of the direct write technique is that different sized and shaped microstructure may be written right next to each other by simply changing the light beam characteristics and/or the proximity for subsequent exposures. Additionally, because the light beam is introduced through the substrate, the microstructures are formed on the surface of the substrate as opposed to many top down exposure systems where the light source is above the photoresist material.

While this direct write process has been described with respect to a master tool for making light extraction materials, the master tool produced by the method describes can be used in alternative application where microstructured surfaces are needed. For example, the master tool created by this process may be used to replicate micro-lens arrays, gain diffusers for LCD displays, structures for reflective or illuminated signs, backlights for automobile dashboards and floating image creation.

Various obvious modifications of this process, the tools which can be formed by the process as well as the numerous structures themselves to which the present invention may be applicable will be readily apparent to those of skill in the art upon review of the present specification and are therefore considered to fall within the scope of the invention.

1. A method of making a replication tool, the method comprising:
forming a master tool wherein the forming step comprises
providing a partially transparent substrate coated with a photo-polymerizable liquid on a first surface of the substrate;
exposing the photo-polymerizable liquid through the substrate at a first position to a light beam having sufficient beam characteristics to cure the photo-polymerizable liquid to form a first tooling structure, wherein the beam characteristics include a beam shape, a beam intensity profile, a total beam intensity and a exposure time;
curing a portion of the photo-polymerizable liquid to form the first tooling structure;
translating the substrate relative to the light beam;
repeating the exposing, curing steps and translating steps a plurality of times to create an array of tooling structures; and
removing any uncured photo-polymerizable liquid, to leave the array of tooling structures disposed on the surface of the substrate;
placing a formable material against a surface of the master tool;
transferring a negative contour of the array of tooling structures on the master tool into the formable material; and
separating the formable material from the master tool.

2. The method of claim 1, further comprising post-curing the tooling structure on the substrate.

3. The method of claim 1, further comprising:
adjusting at least one of the beam characteristics to change the shape of at least one of the tooling structures in the array.

4. The method of claim 1, further providing an adhesion layer on the surface of the substrate, where in the adhesion layer is disposed between the substrate and the photo-polymerizable liquid.

5. The method of claim 1, wherein the first tooling structure is a generally conic section of an aspheric surface shaped projection.

6. The method of claim 1, wherein the beam profile is symmetric.

7. The method of claim 1, wherein the beam profile is asymmetric.

8. The method of claim 1, wherein at least one of the tooling structures in the array is substantially perpendicular to the substrate.

9. The method of claim 1, wherein least one of the tooling structure in the array projects at a non-perpendicular angle from the substrate.

10. The method of claim 1, wherein the replication tool is used to form a light guide.

11. The method of claim 1, wherein the tooling structure is a light extraction tooling structure.

12. The method of claim 1, wherein the photo-polymerizable liquid is a low viscosity liquid and comprises a monomer, a photoinitiator, and an oligomer.

13. The method of claim 12, wherein the viscosity of the photo-polymerizable liquid is less than about 200 cP.

14. The method of claim 13, wherein the viscosity of the photo-polymerizable liquid is less than about 40 cP.

15. The method of claim 12, wherein the photo-polymerizable liquid further comprises a light absorbing material.

16. The method of claim 1, further comprising coating the surface of the master tool with a conductive material.

17. The method of claim 16, wherein the formable material is electrolytically plated onto the surface of the conductively coated master tool.

18. The method of claim 1, wherein the formable material is one of a thermoplastic polymer or a curable resin.

19. The method of claim 1, wherein the light beam used to expose and cure the photo-polymerizable liquid passes through a mask-less optical system.
